(19) United States
(12) Patent Application Publication
(10) Pub. No.: US 2012/0109017 A1
(43) Pub. Date: May 3, 2012

(54) MECHANICAL DEVICE FOR TISSUE REGENERATION

(75) Inventors: Justus Laurens Herder, Den Haag (NL); Eelko Maij, Den Haag (NL); Patrick Hans Warnke, Delft (NL)

(73) Assignee: TECHNISCHE UNIVERSITEIT DELFT, Delft (NL)

(21) Appl. No.: 13/263,261

(22) PCT Filed: Apr. 8, 2010
(86) PCT No.: PCT/NL10/50188

§ 371 Date: Jan. 13, 2012

(30) Foreign Application Priority Data
Apr. 9, 2009 (NL) NL 2002742

(51) Int. Cl. A61H 1/00

(52) U.S. Cl. 601/1

(57) ABSTRACT

The invention relates to a mechanical device for tissue-regeneration inside a patient, comprising means (2, 3) to place a scaffold for the tissue under mechanical stress. Said means comprise a first device-part (2) and a second device-part (3) which parts are arranged to be movable with respect to each other, and wherein the first device-part supports a first receptacle (4) and the second device-part supports a second receptacle (5), which receptacles both have open tops (6, 7) that are pointed towards each other so that both receptacles together define a confined area (8) for holding the scaffold.

The invention relates to a mechanical device for tissue-regeneration inside a patient, comprising means to place at least one scaffold for the tissue under mechanical stress.

WO 2006/109137 teaches a method for tissue regeneration for a patient including the step of providing a scaffold for the replacement tissue, and coating and/or inoculating the scaffold with cells capable of forming or inducing formation of the replacement tissue. The scaffold is implanted inside the patient and the scaffold with the replacement tissue to be grown on the scaffold is harvested when sufficient tissue has formed and angiogenesis of the replacement-tissue has occurred. The scaffold, replacement tissue and blood supply is transplanted or trans-located to where the replacement tissue is required and—if applicable—at least part of the blood supply of the replacement, tissue is reconnected at a local blood vessel near the replacement site. This reconnection to a local blood vessel does for instance relate to bone, but does not apply to cartilage.

It is an object of the invention to provide a mechanical device which is capable to promote tissue regeneration inside the patient for which purpose the device must be embodied so as to place the scaffold for the tissue under mechanical stress, in particular under variable mechanical stress.

The mechanical device of the invention is to that end incorporated with the features as specified in one or more of the appended claims.

In a first aspect of the invention the mechanical device for tissue regeneration is characterized in that the means to place a scaffold for the tissue under mechanical stress comprise a first device-part and a second device-part, which parts are arranged to be movable with respect to each other, and wherein the first device-part supports at least one first receptacle and the second device-part supports at least one second receptacle, which first and second receptacles cooperate for holding a scaffold.

For the avoidance of doubt it is remarked that without departing from the scope of the invention the receptacles can be embodied as an integral part of the device as well as in the form of a part separable therefrom.

The scaffolds can be of any design that is suited for the growth of the concerning tissue for which the device is applied. In fact different types of scaffold can be used simultaneously to grow different types of tissue at the same time with one and the same device.

It is preferable that the receptacles have open tops that are pointed towards each other so that each combination of first and second receptacles together define a confined area or space for holding a scaffold.

With the mechanical device as just specified it is possible to have the scaffold under variable mechanical stress in a manner that makes the device particularly suitable for growing of bones or cartilage.

In order to benefit from the body power that is available inside the patient, and in order to generate the desired variable mechanical stresses to the scaffold it is preferred that the first device-part and the second device-part are arranged to be tied directly or indirectly to different body parts of the patient.

A further desirable feature of the mechanical device for tissue regeneration of the invention is that the receptacles are embodied as cages with gauze-type walls. Due to the gauze-type walls it is possible that the developing tissue can contact the implant environment which allows for diffusion/transport of nutrients and ingrowth of blood vessels which is required to have the tissue grow in or on the scaffold.

It has been found by the inventors that a suitable way of embodying the mechanical device of the invention is that the first device-part and the second device-part are bars that are connected with each other with elements selected from the group comprising couplings and further bars.

This allows the realisation of the mechanical device of the invention in a particularly suitable embodiment having the features that the first device-part and the second device-part are embodied in a frame of bars, which frame has corners where the bars merge, at which corners the frame has a reduced thickness as compared to the remainder of the frame so as to have the corners act as hinge-couplings.

It can further be desirable that it is provided with a mechanical stop to limit the movement of the first device-part and the second device-part with respect to each other.

In a preferred embodiment the device is embodied with a compliant element, such as a spring for providing an interconnection between the device and a body part of the patient. In this embodiment the compliant element acts as a safety-feature that protects against overloading. The compliant element may or may not be pretensioned.

The invention will hereinafter be further elucidated with reference to some exemplary embodiments of the mechanical device of the invention and with reference to the drawing.

In the drawing:

FIGS. 1-6 show schematic graphs of six different embodiments of the mechanical device of the invention,

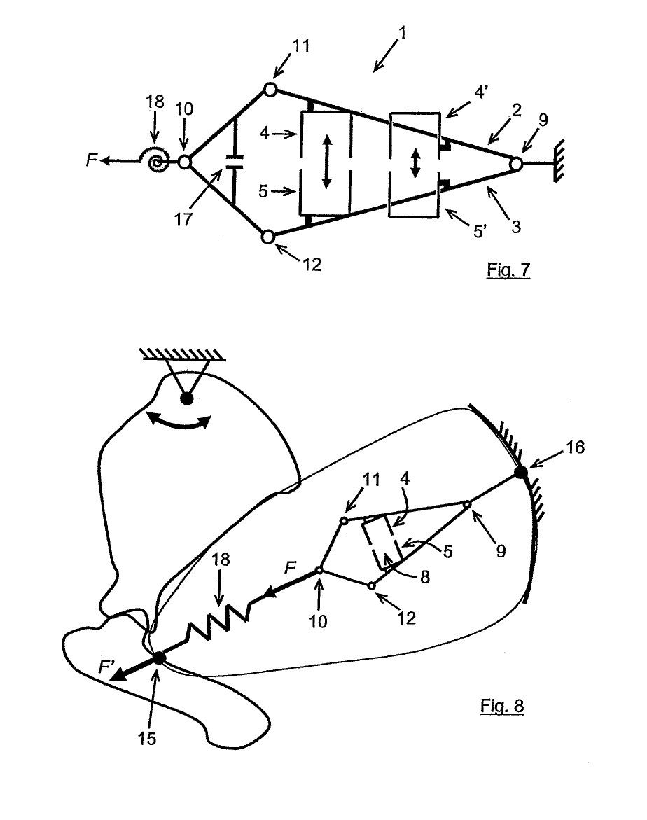

FIG. 7 shows a further graph of an embodiment of the mechanical device of the invention provided with a mechanical stop and a safety-spring,

FIG. 8 shows the embodiment of the mechanical device of the invention shown in FIG. 1 when placed inside and connected to bones of a patient,

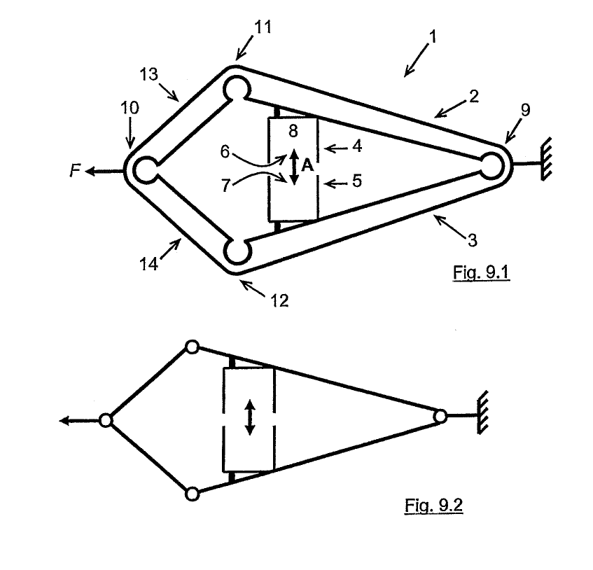

FIGS. 9.1 and 9.2 show respectively a first full scale embodiment and its graphical representation as also shown in FIG. 1,

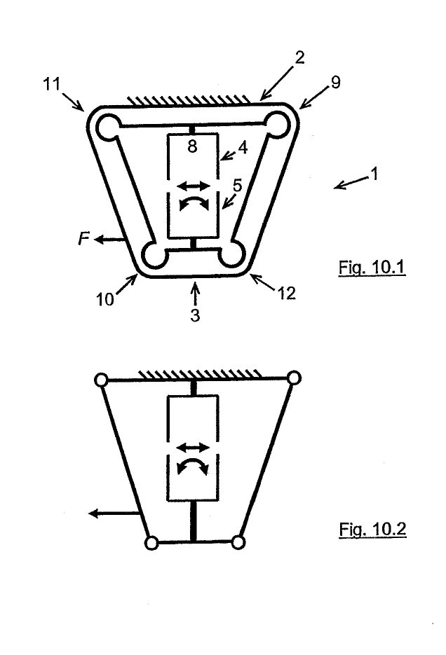

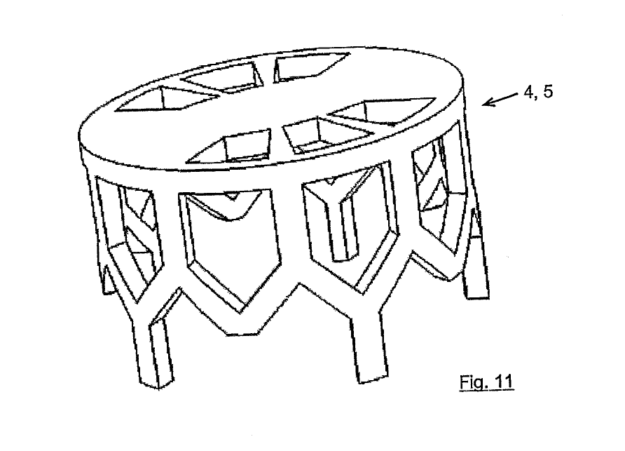

FIGS. 10.1 and 10.2 show a second full scale embodiment of the mechanical device of the invention and its graphical representation; and

FIG. 11 shows a single receptacle separate from the remainder of the mechanical device of the invention.

Wherever in the figures the same reference numerals are applied these numerals refer to the same parts.

With reference first to FIGS. 1-6 the mechanical device of the invention is shown, each time indicated with reference numeral 1.

The mechanical device 1 for tissue regeneration comprises means to place a scaffold for the tissue under mechanical stress. These means are embodied as a first device-part 2 supporting a first receptacle 4, and a second device-part 3 supporting a second receptacle 5, which parts 2, 3 are arranged to be movable with respect to each other. This movability is intended to place stress on a scaffold to be contained in said first receptacle 4 and said second receptacle 5. For this end the said receptacles 4, 5 have open tops 6, 7 that are pointed towards each other so that both receptacles 4, 5 together define a confined area 8 for holding the scaffold. Although it is to be understood that the receptacles 4, 5 can have many different shapes, an exemplary embodiment of one receptacle 4,5 is for illustrative purposes shown in FIG. 11 separate from the remainder of the mechanical device of the invention.

The movability of the first device-part 2 and the second device-part 3 with respect to each other causes that the scaffold to be contained in the combined first and second receptacles 4, 5 undergoes a variable mechanical stress due to a variable movement of the first device-part 2 and the second device-part 3.

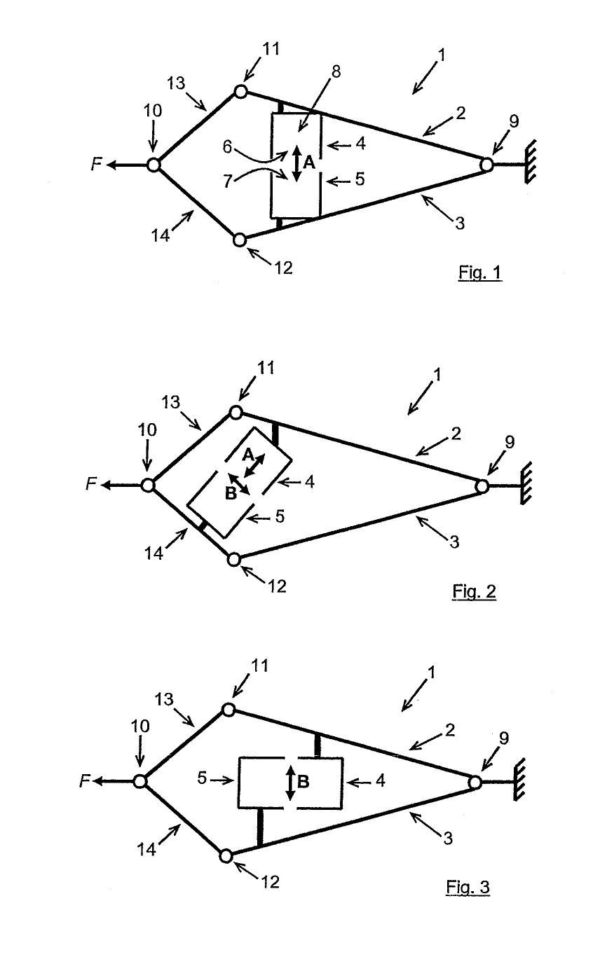

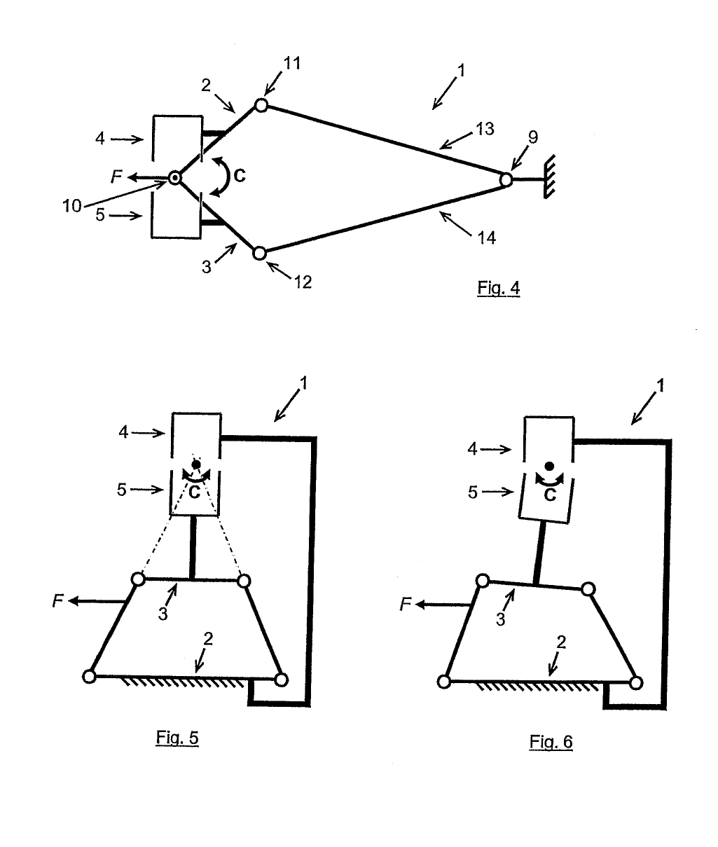

The possible movement that the first receptacle 4 and the second receptacle 5 undertake is directly linked to the construction of the mechanical device. If the mechanical device 1 is considered to be fixed at one extremity 9 and a load F is applied to a further extremity 10 which is distant from the first extremity 9, then it is possible to effect an essentially linear movement A between said receptacles 4, 5 as shown in FIG. 1, possible combined with a lateral movement B as shown in FIG. 2 and FIG. 3, or to effect a rotational movement C as shown in FIGS. 4, 5 and 6.

As all FIGS. 1-6 show, the mechanical device can suitably be embodied by having the first device-part and the second device-part construed as bars 2, 3 that are connected to each other with couplings 9, 10, 11, 12 and further bars 13, 14. In this way it is possible to embody the first device-part 2 and the second device-part 3 in a frame 1 of bars 2, 3, 13, 14 which frame 1 has corners 9, 10, 11, 12 where the bars merge. At said corners 9, 10, 11, 12 the frame 1 has a reduced thickness as compared to the remainder of the frame 1 so as to have the corners 9, 10, 11, 12 act has hinge couplings. This can be clearly seen in FIG. 9.1 and FIG. 10.1, each representing the full scale realisation of the schematic graph of the mechanical device shown in FIG. 9.2 (identifying with FIG. 1) and FIG. 10.2 respectively.

FIG. 7 shows the mechanical device 1 of the invention in which the combination of the first receptacle 4 with the second receptacle 5 is duplicated with the combination of receptacles 4′, 5′. In this embodiment the placement of the first set of receptacles 4, 5 is different to the placement of the second set of receptacles 4′, 5′ in terms of the position at which the receptacles are connected to the first device-part 2 and the second device-part 3. Due to these differing positions the receptacles 4, 5 and 4′, 5′ undergo a different amount of movement when a force F is applied to one of the extremities 10 of the device 1. This causes that also a different amount of mechanical stress is exercised on the scaffold that is to be contained in the second set of receptacles 4′, 5′ as compared to the scaffold contained in the first set of receptacles 4, 5. This may be desirable depending on the type of tissue that is to be grown in said receptacles 4, 5 and 4′, 5′.

With reference further to FIG. 7 the device 1 is incorporated with a mechanical stop 17 providing a limitation to the amount of movement that the first device-part 2 with respect to the second device-part 3 can assume. FIG. 7 also shows a compliant element embodied as a spring 18 that in the mounted condition of the device 1 acts as a safety feature (see also the discussion hereinafter with reference to FIG. 8).

It is remarked that the receptacles 4, 5 are shown in the figures only schematically, yet it is desirable to embody these receptacles as cages with gauze-type walls in order to allow that the developing tissue can contact the implant environment which allows for diffusion/transport of nutrients and ingrowth of blood vessels which is required to have the tissue grow in or on the scaffold.

FIG. 8 schematically shows the embodiment of the mechanical device 1 as shown in FIGS. 1 and 9.2 when this device is placed inside a patient and connected to body parts 15 and 16 of said patient.

It is clear form the schematic drawing of FIG. 8 that movement of the bones 15, 16 of the patient will cause a varying force F′ to be imparted on the mechanical device 1 resulting in varying mechanical stresses on the scaffold held in the area 8 defined by the respective receptacles 4, 5 of said device 1. In order to protect against overload the device 1 is embodied with a compliant element embodied as a spring 18 that connects to one (15) of the body parts (15, 16).

1. Mechanical device for tissue-regeneration inside a patient, comprising means to place at least one scaffold for the tissue under mechanical stress, wherein said means comprise a first device-part and a second device-part, which parts are arranged to be movable with respect to each other, and wherein the first device-part supports at least one first receptacle and the second device-part supports at least one second receptacle, which first and second receptacles cooperate for holding a scaffold.

2. Mechanical device according to claim 1, characterized in that the first and second receptacles have open tops that are pointed towards each other so that each combination of first and second receptacles together define a confined area or space for holding a scaffold.

3. Mechanical device according to claim 1, characterized in that the first device-part and the second device-part are arranged to be tied to different body parts of the patient.

4. Mechanical device according to claim 1, wherein the receptacles are embodied as cages with gauze-type walls.

5. Mechanical device according to claim 1, wherein the first device-part and the second device-part are bars that are connected with each other with elements selected from the group consisting of couplings and further bars.

6. Mechanical device according to claim 1, wherein the first device-part and the second device-part are embodied in a frame of bars, which frame has corners where the bars merge, at which corners the frame has a reduced thickness as compared to the remainder of the frame so as to have the corners act as hinge-couplings.

7. Mechanical device according to claim 1, further comprising a mechanical stop to limit the movement of the first device-part and the second device-part with respect to each other.

8. Mechanical device according to claim 1, further comprising a compliant element for providing an interconnection between the device and a body part of the patient.

9. Mechanical device according to claim 1, further comprising two or more combinations of first and second receptacles supported by the first device-part and the second device-part at differing positions so as to vary the growth-conditions prevailing in said combinations of receptacles.

10. Mechanical device according to claim 8, wherein the compliant element is a spring.
